(19) United States
(12) Patent Application Publication
(10) Pub. No.: US 2005/0144331 A1
(43) Pub. Date: Jun. 30, 2005

(54) On-chip serialized peripheral bus system and operating method thereof

(76) Inventors: Young Woo Kim, Daejeon-Shi (KR); Sung Nam Kim, Daejeon-Shi (KR); Sun Wook Kim, Daejeon-Shi (KR); Kyoung Park, Daejeon-Shi (KR); Myung Joon Kim, Daejeon-Shi (KR)

Correspondence Address: JACOBSON HOLMAN PLLC, 400 SEVENTH STREET N.W., SUITE 600, WASHINGTON, DC, 20004, US

(21) Appl. No.: 10/913,418

(22) Filed: Aug. 9, 2004

(30) Foreign Application Priority Data
Dec. 24, 2003 (KR) 2003-96040

(51) Int. Cl. G06F 3/00

(52) U.S. Cl. 710/5

(57) ABSTRACT

Provided is an on-chip serialized peripheral bus system and method of operating the same, wherein when a plurality of low-speed peripherals are connected to a system that employs a high-speed parallel bus, the existing parallel bus system for connecting the low-speed peripheral becomes serialized, thereby reducing a bus width of the parallel bus as well as improving a connection response time of the low-speed peripheral, and reducing a simultaneous transition frequency of the peripheral connection bus system to improve the performance of the overall system.

### BACKGROUND

1. Field of the Invention

The present invention relates to an on-chip serialized peripheral bus system and method of operating the same and, more specifically, to an on-chip serialized peripheral bus system and method of operating the same wherein when a plurality of low-speed peripherals are connected to a system that employs a high-speed parallel bus, the existing parallel bus system for connecting the low-speed peripheral becomes serialized, thereby reducing a bus width of the parallel bus as well as improving a connection response time of the low-speed peripheral, and reducing a simultaneous transition frequency of the peripheral-connection bus system to improve the performance of the overall system.

2. Discussion of Related Art

FIG. 1 is an overall block diagram showing a conventional on-chip system bus architecture, and FIG. 2 is a timing diagram for explaining a method of operating the on-chip system bus.

As shown in FIGS. 1 and 2, the on-chip system bus architecture according to the prior art has a configuration that a high-speed parallel system bus and a low-speed parallel peripheral bus are connected with a high-speed/low-speed parallel bus bridge 30, wherein the high-speed parallel system bus has a configuration that a high-speed memory interface 12, an on-chip memory 13 and a high-speed DMA device 14 and the like are connected with each other through a parallel system bus 10 by centering a high-performance processor 11; and the low-speed parallel peripheral bus has a configuration that low-speed peripherals such as a UART 21, a timer 22, a PIO 23 and a keyboard 24 are connected with each other through a parallel peripheral bus 20.

With such high-speed parallel system bus and low-speed parallel peripheral bus, the peripheral bus outputs a delayed response to the high-speed system bus due to a speed difference in operation.

Generally, the low-speed parallel peripheral bus is operable in a low operating frequency because of its slow response of the device connected to the external, having a drawback arising from the fact that a plurality of peripherals are all connected to a single peripheral bus, so that its response becomes slower as the requests from the high-speed bus for using the peripheral occur more frequent.

Further, in a common bus architecture sharing a single bus, as the number of the connected device increases, the bus load also increases to result in shortness in improving the operating speed. And parallel signal lines having much load simultaneously transition, which causes a high transient power to be required at the time of the simultaneous transition and interference between the bus signal lines.

For example, U.S. Pat. No. 5,649,124, entitled “High-Speed Bus System for Simultaneous Serial and Parallel Data Transfer and method of operating the same” by Josef Kreidl, disclosed an architecture that input parallel data are transmitted in series with a faster clock as much as the number of bits of the input data rate in order to transmit parallel data in series. As such, by transmitting with converting parallel data into serial data, the bus width for data is reduced, and also, by using a parallel bus together and reducing an occupation time of the parallel bus, the high-speed data transfer is implemented. However, it requires a serial clock with n-times of the parallel bus clock so as to transmit n bits of data, so that there is a problem that a faster clock should be employed in transmitting data with wider bit width.

Meanwhile, Korean Patent Publication No. 1998-0007260 (a circuit transmitting data via a serial bus) by Samsung Electronics relates to a circuit that transmits data through a serial bus under the multiple processor environment, comprising a generator of a bus occupation signal for bus activation, and a serialized transmitter/receiver circuit, when data is transmitted through serial bus connected to each processor. It is directed to a data transfer to each processor under the multiprocessor environment, without accounting an environment for connecting the external peripheral, and further, it has a problem that additional clock should be used since a parallel bus clock is separate with a serial bus clock.

Additionally, Korean Patent Publication No. 1986-0000597 (a slave-type interface circuit operating as a serial bus) by Stephan Barbu discloses a slave-type interface circuit cooperative with a serial bus that has a data signal line SDA and a clock signal line SCL, defining a block structure of the slave-type interface, and an internal memory structure necessary to this, and a circuit for controlling a signal, where the slave-type interface is connected to the serial signal that uses a specific signal line. However, there is a problem of inadequate facilities to adopt it to a high speed operation because the interface of the serial bus is designed to transmit address/data/control by means of a single signal line.

### SUMMARY OF THE INVENTION

The present invention is directed to an on-chip serialized peripheral bus system and method of operating the same and, more specifically, to an on-chip serialized peripheral bus system and method of operating the same wherein when a plurality of low-speed peripherals are connected to a system that employs a high-speed parallel bus, an existing parallel bus system for connecting the low-speed peripheral becomes serialized, thereby reducing a bus width of the parallel bus as well as improving a connection response time of the low-speed peripheral, and reducing a simultaneous transition frequency of the peripheral connection bus system to improve the performance of the overall system and to implement a low power peripheral bus system.

According to one aspect of the present invention, the on-chip serialized peripheral bus system for a microprocessor system that employs a high-speed parallel system bus comprises: a plurality of on-chip serialized peripheral buses each connected to a plurality of on-chip serialized peripherals and having a plurality of serialized signal lines; and a on-chip parallel to serial bridge for connecting the on-chip serialized peripheral bus and the high-speed parallel system bus.

In the above configuration, the on-chip parallel to serial bridge comprises a transaction controller for controlling an internal read/write transaction and managing each buffer; a read/write address buffer for reading/writing of the data address transmitted from the on-chip serialized peripheral bus; a write data buffer for writing data transmitted from the on-chip serialized peripheral bus; a read data buffer for reading data transmitted from the on-chip serialized peripheral bus; a read/write transaction multiplexer for selecting a corresponding on-chip serialized peripheral; a read data demultiplexer for classifying a read response from the on-chip peripheral; at least one read/write transaction serializer; and at least one read data parallelizer.

According to another aspect of the present invention, a method of operating an on-chip serialized peripheral bus system comprising a plurality of serialized peripheral buses each connected to a plurality of serialized peripherals and having a plurality of serialized signal lines; and a parallel to serial bridge for connecting the on-chip serialized peripheral bus to a high-speed parallel system bus, the method comprises the steps of: (a) classifying a transaction type to process a transaction of the high-speed parallel system bus; (b) determining a space state of each internal buffer; (c) allocating a unique number to each request; (d) transferring the request to the on-chip serialized peripheral bus in accordance with a state of a read/write request buffer; and (e) responding to the high-speed parallel system bus.

### BRIEF DESCRIPTION OF THE DRAWINGS

FIG. 1 is an overall block diagram showing a conventional on-chip system bus architecture;

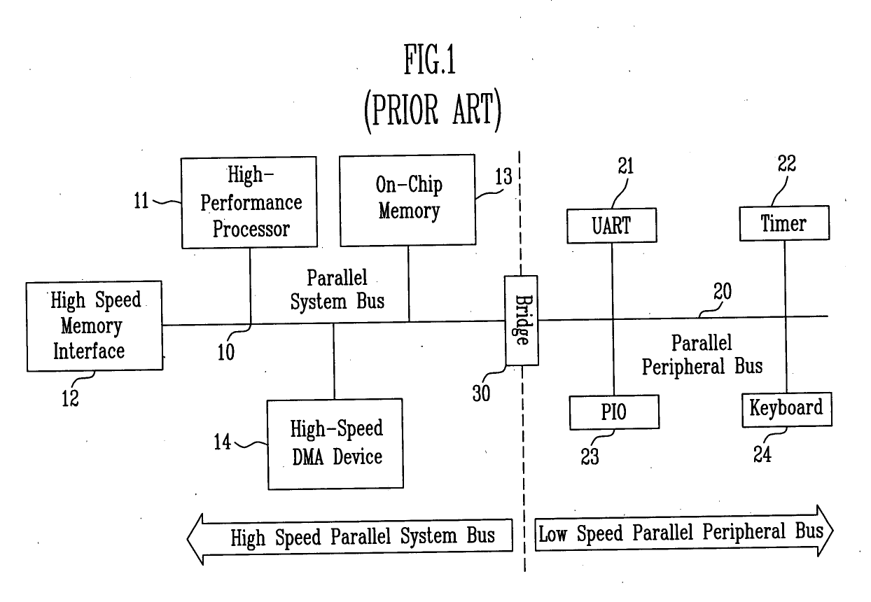

FIG. 2 is a timing diagram for explaining a method of operating the on-chip system bus of FIG. 1;

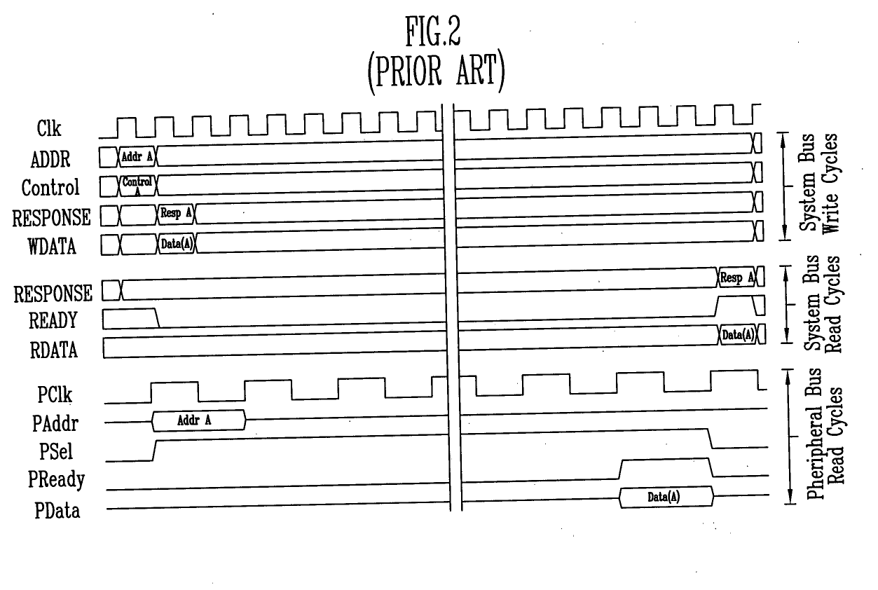

FIG. 3 is an overall block diagram showing an on-chip serialized peripheral bus according to an embodiment of the present invention;

FIG. 4 is a detailed timing diagram for specifically illustrating a single read/write of a signal according to an embodiment of the present invention;

FIG. 5 a detailed timing diagram for specifically illustrating a plurality of read/write of a signal according to an embodiment of the present invention;

FIG. 6 is a block diagram specifically showing a controller of an on-chip serialized peripheral bus system according to an embodiment of the present invention.

FIG. 7 is a flow chart for illustrating a high-speed parallel system bus transaction process of an on-chip serialized peripheral controller according to an embodiment of the present invention; and

FIG. 8 is a flow chart for illustrating a serialized peripheral bus transaction process of an on-chip serialized peripheral controller according to an embodiment of the present invention.

### DETAILED DESCRIPTION OF PREFERRED EMBODIMENTS

The preferred embodiments of the present invention will now be described with reference to the accompanying drawings. These embodiments are not limitative to the scope of the present invention, but just illustrative.

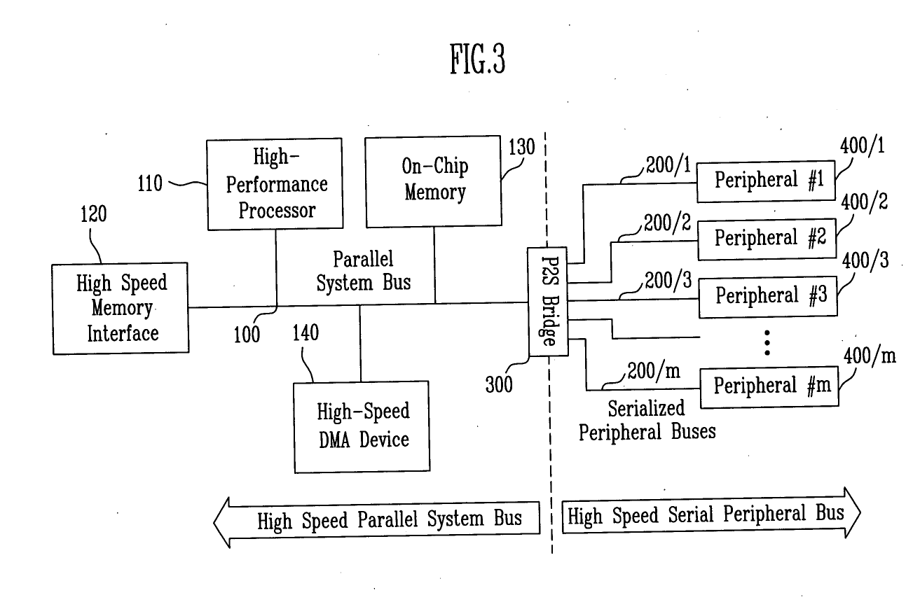

FIG. 3 is an overall block diagram showing an on-chip serialized peripheral bus system according to an embodiment of the present invention.

As shown in FIG. 3, the on-chip serialized peripheral bus system according to the present invention comprises a on-chip parallel to serial bridge (hereinafter, referred to as ‘P2S Bridge’) 300 connected with the existing high-speed parallel bus system; a plurality of on-chip serialized peripheral buses 200/1˜200/m starting from the P2S Bridge 300 and having addresses, write data, read data and control signals; and on-chip serialized peripherals 400/1˜400/m connected to each of the on-chip serialized peripheral buses 200/1˜200/m.

In other words, the on chip serialized peripheral bus system comprises the P2S Bridge 300, which is an on-chip serialized peripheral controller, used as a center, an existing high-speed parallel system bus 100, m serialized peripheral buses 200/1˜200/m having a plurality of serialized signal lines, and m on-chip serialized peripherals 400/1˜400/m connected to each of the m serialized peripheral buses.

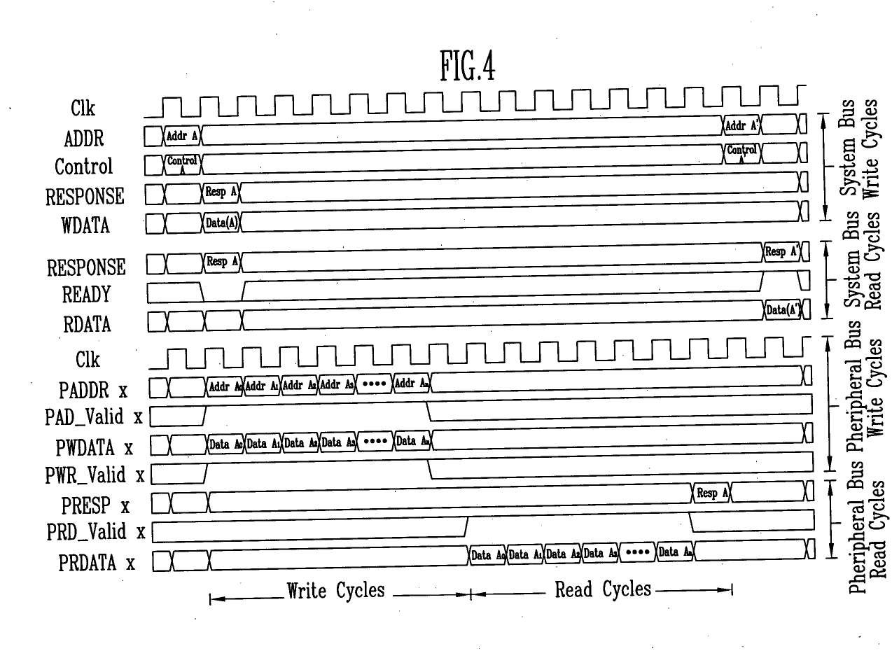

FIG. 4 is a timing diagram for specifically illustrating a single read/write of a signal according to an embodiment of the present invention, which is a detailed timing diagram of a main signal and read/write for the high-speed parallel system bus 100 according to the on-chip serialized peripheral bus system configuration of FIG. 3 and for the on-chip serialized peripheral buses 200/1˜200/m intended to implement in the present invention.

As shown in FIG. 4, the existing parallel peripheral bus 20 described above is characterized in that it operates using its slow response, and accordingly, a low frequency clock. When one simply intends to convert this into a serial bus, if a clock corresponding to multiples of the data width is employed, a faster clock will be required in order to process at the same speed as the existing high-speed system.

However, as the peripheral operates at a low speed relative to the high-speed system bus (several times or several ten times), the peripheral bus can be serialized by using this and the low-speed peripheral bus can be serialized without an additional clock by using the same clock as used in the high-speed system.

Here, when a parallel common bus is simply converted into a serial common bus, it can show lower performance than the low-speed parallel bus due to a bottleneck for the sharing. To address this, the on-chip serialized peripheral buses 200/1˜200/m comprises a point-to-point scheme bus system connected to the on-chip serialized peripherals 400/1˜400/m and using the P2S Bridge 300 as a starting point, thereby improving the system performance so that each on-chip serialized peripheral 400/1˜400/m can operate independently.

Generally, the high-speed parallel system bus 100 requires signal lines such as addresses ADDR, write data WDATA, read data RDATA, Control, Response, and READY, connected in parallel.

First, a write transaction (System Bus Write Cycle of FIG. 4) into the on-chip serialized peripheral buses 200/1˜200/m in the high-speed parallel system bus 100 is started by generating control signal information that corresponds to the address and write data for the high-speed parallel system bus 100. Since the write operation, which is a kind of a Posted operation, does not require a response at the end point, the suggested P2S Bridge 300 automatically generates the corresponding response, and loads the response onto response signal lines, thereby ending the write operation of the high-speed parallel system bus 10.

The P2S Bridge 300 receiving a write operation instruction transmits the write addresses to PADDR x (1 line), which is the corresponding on-chip peripheral serialized address bus, and the write data to PWDATA x (1 line) (Peripheral Bus Write Cycle of FIG.4), with the serialized corresponding data. Here, in order to indicate start and end of the data and the address, the corresponding on-chip serialized peripherals 400/1˜400/m generates a response PRESP x signal, which is a confirmation signal for the receipt of all data, to complete the write operation (Here, x is a signal line extension name for identifying the selected on-chip serial peripheral) by using each valid signal, PAD_Valid x and PWR_Valid x, to inform the on-chip serial peripherals 400/1˜400m of the start and end of the serial data.

Next, a read transaction (System Bus Read Cycle) to the on-chip serialized peripheral buses 200/1˜200/m in the high-speed parallel system bus 100 requires a receipt of the read data contrary to the write transaction, so that it cannot retrieve the spontaneous read data at the P2S Bridge 300. Here, when waiting for the read data, the next read/write transaction is prohibited, thereby degrading the system performance.

Assuming this, the general high-speed parallel system bus 100 provides a Split transaction and a Retry mechanism. The P2S Bridge 300 suggested in the present invention supports a Split/Retry transaction of the high-speed parallel system bus 100 for burst processing of the read transaction.

That is, when the read transaction to the on-chip serialized peripheral buses 200/1˜200/m is generated in the high-speed parallel system bus 100, the P2S Bridge 300 processes this with the Split or Retry transaction, so that when the data is ready to the high-speed parallel system bus 100, it is informed that retransmission can be requested. Here, the P2S Bridge 300 indicates the corresponding transaction to split and retry, using a ready signal READY and a response signal RESPONSE of the high-speed parallel system bus 100 (corresponding to Resp A in FIG. 4).

The P2S Bridge 300 receiving the read request generates a PADDR x signal and an address valid PAD_Valid x signal for a read transaction as for the write one, and the on-chip serialized peripherals 400/1˜400/m receiving these respond to the read data using a read data PRDATA x signal and a read valid PRD_Valid x signal, and then, generates a PRESP x signal for completion of the corresponding read transaction (Peripheral Bus Read Cycle in FIG. 4).

The P2S Bridge 300 stores the read data received from the on-chip serialized peripherals 400/1˜400/m, and waits for the Split or Retry transaction from the high-speed parallel system bus 100. Finally, when the Split/Retry read transaction (corresponding to Addr A′, Control A′ in FIG. 4) for the corresponding address is generated, the stored read result value (Resp A′, Data(A′) in FIG. 4) is transmitted to the high-speed parallel system bus 100 to end the read transaction.

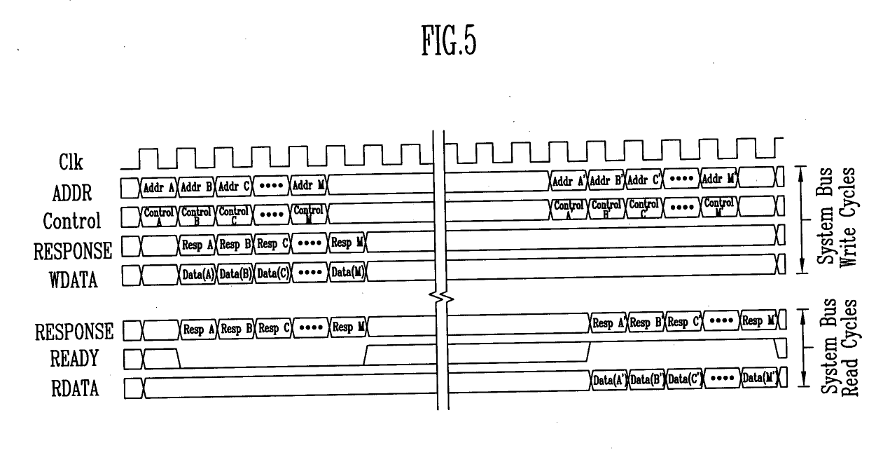

FIG. 5 is a detailed timing diagram for specifically illustrating a plurality of read/write of a signal according to an embodiment of the present invention, which extends the detailed timing diagram of the single read/write operation of FIG. 4.

As shown in FIG. 5, which is the detailed timing diagram of the plural read/write for subsequently generated burst transaction, the read or write transaction are successively applied to the plurality of on-chip serialized peripherals 400/1˜400/m. For the write transaction, the P2S Bridge 300 stores address and write data using an internal buffer, and transmits the address and write data to the corresponding on-chip serialized peripheral 400/1˜400/m at the same time, so that a parallelization feature for the on-chip serialized peripheral buses 200/1˜200/m is used. For the read transaction, it also stores the corresponding address into the internal buffer and performs the read request for each on-chip serialized peripherals 400/1˜400/m at the same time, and processes the response from the plurality of on-chip serialized peripherals 400/1˜400/m at the same time, thereby improving the performance of the on-chip serialized peripheral buses 200/1˜200/m.

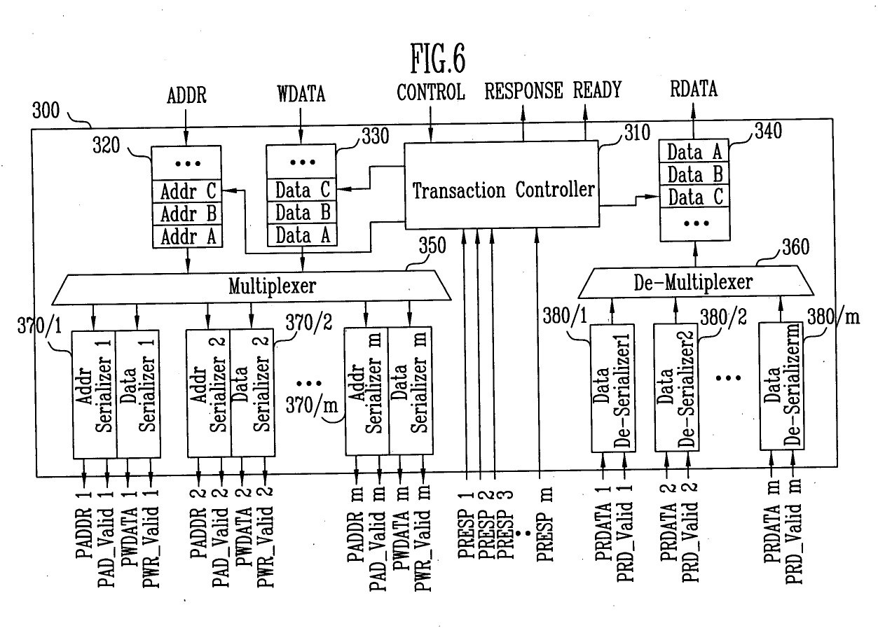

FIG. 6 is a block diagram specifically showing a controller of an on-chip serialized peripheral bus system according to an embodiment of the present invention.

As shown in FIG. 6, the P2S Bridge 300, which is an on-chip serialized peripheral controller according to the present invention, comprises a transaction controller 310 for controlling internal read/write transactions and managing each buffer; a read/write address buffer 320 for performing reading/writing of the data transmitted from the on-chip serialized peripheral buses 200/1˜200/m; a write data buffer 330 for performing the writing of the data transmitted from the on-chip serialized peripheral buses 200/1˜200/m; a read data buffer 340 for performing the reading of the data transmitted from the on-chip serialized peripheral buses 200/1˜200/m; a read/write transaction multiplexer 350 for selecting the corresponding on-chip serialized peripherals 400/1˜400/m; a read data de-multiplexer 360 for classifying a read response from the on-chip serialized peripherals 400/1˜400/m; m read/write transaction serializers 370/1˜370/m; and m read data parallelizers 380/1˜380/m.

The read/write transaction from the high-speed parallel system bus 100 is first stored into the read/write address buffer 320 and the write data buffer 330, respectively. Here, the transaction controller 310 allocates to the corresponding transaction the transaction number that is not overlapped with each other and makes each transaction identifiable, and returns the Split/Retry or the Good response based on the read/write transaction to the high-speed parallel system bus 100 to complete the transmission of the high-speed parallel system bus 100.

Each buffer, which performs a First In First Out operation, retrieves from the first stored read/write transaction and transmits it to the read/write transaction multiplexer 350, and the read/write transaction multiplexer 350 transmits the data to the read/write transaction serializer 370/1˜370/m that corresponds to the on-chip serialized peripherals 400/1˜400/m that is to transmit the transaction based on the allocated address. The selected read/write transaction serializers 370/1˜370/m serialize the input read/write transaction address data to transmit to the corresponding on-chip serialized peripherals 400/1˜400/m.

In the case of the read transaction, the response returning from each on-chip serial peripherals 400/1˜400/m is converted into the parallel data through the read data parallelizers 380/1˜380/m, and the read data de-multiplexer 360 selects the converted data and stores it into the read data buffer 340. Here, the data is stored into the corresponding read data buffer 340 using the transaction number used in transmitting the read transaction and the address allocated to the on-chip serialized peripherals 400/1˜400/m. The read data buffer 340 also performs the First In First Out operation, and the stored read data is transmitted into the high-speed system bus 100 one after another as stored.

A method of operating an on-chip serialized peripheral bus system of the present invention having the foregoing configuration will now be specifically described.

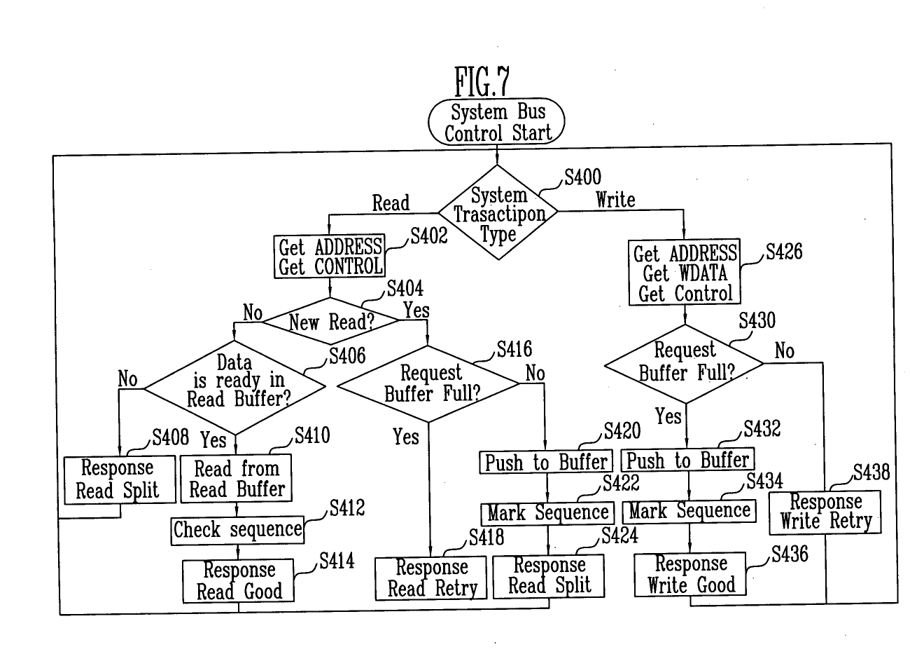

FIG. 7 is a flow chart for illustrating a high-speed system bus transaction process of the on-chip serialized peripheral controller according to an embodiment of the present invention.

As shown in FIG. 7, as a procedure for processing the transaction of the high-speed parallel system bus 100, first, it is determined whether a system transaction type is a read transaction or a write transaction at the starting point (S400). As a result of the determination, when it is determined that the system transaction type is the read transaction, the Address and the Control signals are stored into the high-speed parallel system bus 100 (S402).

Next, it is determined whether it is a new read transaction that is not processed with the Split transaction before (S404). As a result of the determination, when the new transaction, it is checked whether an empty space is allocated in the read/write address buffer 320 (S416).

Here, when there is the empty space in the read/write address buffer 320, the corresponding address is pushed into the read/write address buffer 320 (S420), and a new transaction number is marked (S422), and then, the high-speed parallel system bus side is informed of the Split transaction (S424). When there is no allocated buffer space, the high-speed parallel system bus side is informed to retry the corresponding read transaction (S418).

When the request at the high-speed parallel system bus 100 is one that processed before with the Split transaction rather than the new transaction, it is checked whether the response to the corresponding request is ready in the read data buffer (S406). As a result of the checking, when the corresponding data does not exist, the high-speed parallel system bus side is informed to perform the Split transaction again (S408), and when the corresponding data exists, the data from the read/write address buffer 320 is read out (S410), and the transaction sequence is checked (S412), and then, after loading the data on the high-speed parallel system bus 100, the response corresponding to the reading Good is transmitted (S414).

In the case of the write transaction, the address, the control, and the data signal are stored into the high-speed parallel system bus 100 (S426). Next, it is checked whether an empty space is allocated to the write data buffer 330 (S430), and when the empty space exists in the write data buffer 330, the corresponding address and write data are pushed into the write data buffer 330 (S432), and a new transaction number is marked (S434), and then, the response corresponding to the writing Good is transmitted to the high-speed parallel system bus side (S436). If the write data buffer 330 is fully filled, the corresponding request cannot be processed, so that the high-speed parallel system bus side is informed to retry the corresponding write transaction to (S438).

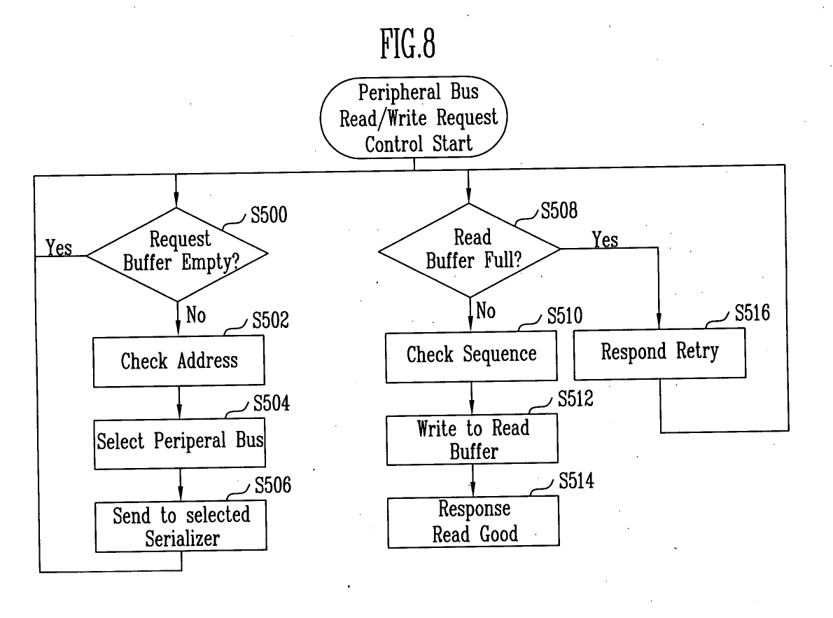

FIG. 8 is a flow chart for illustrating a serialized peripheral bus transaction process of the on-chip serialized peripheral controller according to an embodiment of the present invention.

As shown in FIG. 8, a procedure for processing the read/write request transaction to the on-chip serialized peripheral buses 200/1˜200/m and a procedure for processing the read data are performed in parallel.

First, in order to process the read/write request transaction, the read/write address buffer 320 and the write data buffer 330 are checked (S500). As a result the checking, when the new request is stored in each of the buffers 320 and 330, the address is checked (S502) and the corresponding on-chip serialized peripheral 400/1˜400/m is selected (S504), and then, the address for the read request and the address and the write data for the write request are sent to the selected read/write transaction serializer 370/1˜370/m (S506).

In the procedure for processing the read data, first, it is checked whether the data is fully filled in the read data buffer 340 (S508). When there is a room to the read data buffer 340, the transaction number corresponding to the on-chip serialized peripheral 400/1˜400/m that reads out the data is checked (S510). When the transaction number check is completed, the read data is stored into the read data buffer 340 (S512), and then, a Good response is transmitted to the on-chip serialized peripheral 400/1˜400/m that transmits the read data (S514). If the read data buffer 340 is fully filled, the Retry response is transmitted to the corresponding on-chip serialized peripheral 400/1˜400/m, and retransmission is requested until the read data buffer 340 becomes empty (S516).

Although the preferred embodiments for an on-chip serialized peripheral bus system and method of operating the same according to the present invention have been described, the present invention is not limited hereto, but rather, a variety of changes can be made within the claims and the detailed description of the invention and the accompanying drawings, which is also included in the invention.

As described above, according to the on-chip serialized peripheral bus system and method of operating the same of the present invention, the parallel bus for the low-speed peripherals is converted into the serial bus, while the performance of the high-speed parallel system bus is not degraded, and the peripheral bus is pluralized by allocating the independent serialized bus to each peripheral, and these are connected in a point-to-point manner, thereby having an advantage that the system performance can be improved through the parallelization of the peripheral bus system.

Further, the on-chip serialized peripheral bus system and method of operating the same according to the present invention employ the clock used in the high-speed parallel bus with respect to the operating speed of the serialized peripheral bus, thereby having an advantage that a problem due to a difference of the phase/frequency of the clock that can be generated using a plurality of clocks in the single system bus can be blocked.

Further, by making the bus signal serialized and pluralized, a problem of an instantaneous power due to the transition of the simultaneous signal line can be addressed, and as one peripheral is connected to one serial bus, there is an advantage that a load issue can be solved that is one of issues to the parallel common bus.

1. An on-chip serialized peripheral bus system for a microprocessor system that employs a high-speed parallel system bus comprising:
a plurality of on-chip serialized peripheral buses each connected to a plurality of on-chip serialized peripherals and having a plurality of serialized signal lines; and
a on-chip parallel to serial bridge for connecting the on-chip serialized peripheral bus to the high-speed parallel system bus.

2. The on-chip serialized peripheral bus system according to claim 1, wherein the plurality of serialized signal lines includes an address, write data, read data and control signal lines.

3. The on-chip serialized peripheral bus system according to claim 1, wherein, the on-chip serialized peripheral bus separated from the high-speed parallel system bus is used for the high-speed operation of the on-chip serialized peripheral.

4. The on-chip serialized peripheral bus system according to claim 1, wherein, for the high-speed operation of the on-chip serialized peripheral, the on-chip serialized peripheral bus is connected to the on-chip serialized peripheral in a point-to-point manner, using the parallel to serial bridge as a starting point.

5. The on-chip serialized peripheral bus system according to claim 4, wherein the on-chip serialized peripheral bus comprises
a bit of request address bus and a bit of valid signal informing of a start and an end of the address;
a bit of write data bus and a bit of valid signal informing of a start and an end of the data;
a bit of read data bus and a bit of valid signal informing of a start and an end of the data; and
a response signal to the read data.

6. The on-chip serialized peripheral bus system according to claims 1, wherein the on-chip parallel to serial bridge comprises
a transaction controller for controlling an internal read/write transaction and managing each buffer;
a read/write address buffer for reading/writing of the data address transmitted from the on-chip serialized peripheral bus;
a write data buffer for writing data transmitted from the on-chip serialized peripheral bus;
a read data buffer for reading data transmitted from the on-chip serialized peripheral bus;
a read/write transaction multiplexer for selecting a corresponding on-chip serialized peripheral;
a read data demultiplexer for classifying a read response from the on-chip serialized peripheral;
at least one read/write transaction serializer; and
at least one read data parallelizer.

7. A method of operating an on-chip serialized peripheral bus system comprising a plurality of serialized peripheral buses each connected to a plurality of serialized peripherals and having a plurality of serialized signal lines; and a parallel to serial bridge for connecting the on-chip serialized peripheral bus to a high-speed parallel system bus, the method comprising the steps of:
(a) classifying a transaction type to process a transaction of the high-speed parallel system bus;
(b) determining a space state of each internal buffer;
(c) allocating a unique number to each request;
(d) transferring the request to the on-chip serialized peripheral bus in accordance with a state of a read/write request buffer; and
(e) responding to the high-speed parallel system bus.

8. The method according to claim 7, wherein the step (a) for processing the transaction of the on-chip serialized peripheral bus further comprising the sub steps of:
(a-1) determining the space state of the internal buffer;
(a-2) selecting the on-chip serialized peripheral bus in accordance with the read/write request address;
(a-3) transmitting the data to a serializer that corresponds to the selected on-chip serialized peripheral;
(a-4) checking the unique number of the read response data;
(a-5) storing the read data into the buffer; and
(a-6) generating the response that corresponds to the read data.
